(19) United States
(12) Patent Application Publication
(10) Pub. No.: US 2003/0093382 A1
(43) Pub. Date: May 15, 2003

(54) Method for producing/selling book using network and producing/selling system

(76) Inventors: Yasunori Himeno, Tokyo (JP); Toshihiro Takagi, Saitama-shi (JP); Toru Yagi, Tokyo (JP)

Correspondence Address: Striker Striker & Stenby, 103 East Neck Road, Huntington, NY, 11743, US

(21) Appl. No.: 09/914,898

(22) PCT Filed: Jun. 12, 2001
(86) PCT No.: PCT/JP01/04938

(30) Foreign Application Priority Data
Jun. 15, 2000 (JP) 2000-179988

(51) Int. Cl. G06F 17/60

(52) U.S. Cl. 705/51

(57) ABSTRACT

A method of realizing a series of process using one client application, from when a publisher prepares an electronic book file until when this book file is sold to a client via a network. A publisher terminal (2), a client terminal (3), and an electronic publication service site (4) are connected each other via a network (5). A publisher prepares an electronic book file comprising a copyright protection function by using an electronic book preparation/reading application (9), and uploads this book file to the electronic publication service site (4) by using this application (9). The electronic publication service site registers and stores the uploaded book file so that the book file can be immediately sold to a client. The client can obtain the book file that he/she purchased, in the form of an electronic book or a general book by reading the contents registered in a search/read information database (14) of the electronic publication service site (4) by using the electronic book preparation/reading application (9).

### BACKGROUND OF THE INVENTION

1. Field of the Invention

The present invention relates to an electronic book preparation/selling method and preparation/selling system for selling books prepared by a publisher to a client or a user by utilizing a network.

2. Description of the Related Art

With the recent progress of the information and communications industries, there have been wide spreads of contents (information, services, products, and money) distribution services by utilizing the Internet. Under such circumstances, there have been proposed electronic documents selling services that are services for preparing electronic books based on books prepared by publishers, and selling these electronic books to clients who want to purchase these electronic books via the Internet. Attempts have been made to put these proposals into practice.

A conventional system of publishing and selling electronic books will be explained below. First, a publisher prepares an electronic book to be published by inputting the contents of the book into a disk using a word processor. The publisher then prepares a book file in a form of publication using layout software. Then, the publisher changes the book file into a format that can be uploaded or downloaded as an electronic book by using electronic book software. Thus, the electronic book is prepared in a status that it can be published.

Further, the publisher communicates with a selling agent site that is connected with the publisher via the Internet, or members in charge in both parties actually meet, to discuss the following items. Namely, both parties discuss items relating to the publication, including the setting of the selling price of the electronic book prepared, the addition of the copyright protection function, the setting of a payment system, and the extent of disclosure of the contents of the electronic book to clients as read information. After the publication form has been determined, the selling agent site makes open on the Web server the electronic book prepared by the publisher. At the same time, the selling agent site prepares book databased on the electronic book so that a potential client can search for the book data via the Internet, and then stores the book data in the database of the selling agent site. Using a credit settlement procedure, a client who wants to purchase the electronic book downloads the desired electronic book to the terminal in exchange for the payment via the Internet, and thus obtains the electronic book.

However, according to the above method of publishing and selling an electronic book, the procedures of setting the format and setting the publishing form are necessary, during the period from when the publisher has prepared the document of the book file until when the electronic book is sold to the client. Therefore, a large amount of work is forced to the members in charge in the publisher and the selling agent site. As a result, even when a publisher who has prepared a book file wants to publish this book file as an electronic book, the publisher has to abandon this desire in many cases because of the complexity of the procedures that utilize a plurality of applications. Some of the conventional electronic books do not have the copyright protection function. Therefore, the clients have not been able to enjoy the merit of purchasing the electronic books. In other words, the clients have not been able to enjoy the conveniences of reading, searching, reference, and citing of electronic books provided from the publishers.

As explained above, according to the conventional electronic hook selling services, it has been desired to build up a system for enabling a client to purchase and read an electronic book in a simple procedure, during the process from when a publisher prepares a draft and completes an electronic book till when the publisher sells the electronic book and collects the charge via the Internet. Further, according to the conventional system of publishing and selling an electronic book, a book file prepared by a publisher is sold to a client in the form of an electronic book. The client has not been able to purchase the book as a printed book or a document printed on paper (this is called a general book). Therefore, it has been desired to build up a system for enabling a book to be printed as many copies as needed when a general book is necessary, based on the book file prepared by the publisher.

### SUMMARY OF THE INVENTION

The object of the present invention is to provide a book preparation/selling method and a book preparation/selling system using a network capable of publishing a book prepared by a publisher and selling the book to a client, in a simple method. Further, it is another object of the invention to provide a system for efficiently realizing a knowledge/information circulation system based on an electronic document, in one application.

In order to achieve the above objects, according to one aspect of the present invention, there is provided a method of realizing a series of processes using one client application, from when a publisher prepares an electronic book file till when this book file is sold to a client via a network. A publisher terminal, a client terminal, and an electronic publication service site are connected to each other via a network. A publisher prepares an electronic book file provided with a copyright protection function by using an electronic book preparation/reading application, and uploads this book file to the electronic publication service site by using the same application. The electronic publication service site registers and stores the uploaded book file so that the book file can be immediately sold to a client. The client reads the contents registered in a search/read information database of the electronic publication service site by using the electronic book preparation/reading application. Thus, the client reads the desired book file and stores charge data of the book file that he/she wants to purchase, by relating the charge data to the client and the publisher. After that, the client can obtain the book file that he/she purchases, in the form of an electronic book or a general book.

Further, according to another aspect of the present invention, the publisher terminal and the client terminal have the electronic book preparation/reading application for enabling the publisher to prepare a book file that can be directly accessed to the electronic publication service site via the network. They also have the application for enabling the client to directly search the electronic publication service site for the book file registered in the electronic publication service site and read this book file via the network.

The electronic publication service site stores the book file and the publisher terminal by relating them to each other, and prepares a search/read file based on the contents of the book file. The client searches the search/read file for a book file that he/she wants to purchase, selects and obtains the book file by using the electronic book preparation/reading application, and stores the charge data of the purchased book file in the electronic publication service site by relating the charge data to the client and the publisher.

Further, still according to another aspect of the invention, a publisher prepares a book file using an electronic book preparation/reading application. An electronic publication service site has a book file storing unit for storing the book file prepared by the publisher by relating the book file to the publisher, a search/read information storing unit for preparing and storing a search/read file of the book file stored in the book file storing unit, and a sales management data storing unit for storing charge data of the book file sold to the client. The client searches for a book file stored in the search/read information storing unit and reads the searched book file by using the electronic book preparation/reading application, and selects a book file that he/she wants to purchase. The electronic publication service site down loads the book file selected by the client to him/her as an electronic book, charges the client for the price of the selected book file, and stores the charge data in the sales management data storing unit.

As explained above, the system of the present invention is characterized in that it is possible to efficiently realize a knowledge/information circulation system of a report, a thesis, or a book, using one application.

### BRIEF DESCRIPTION OF THE DRAWINGS

FIG. 1 is a block diagram showing a structure of a system according to one embodiment of the present invention;

FIG. 2 is a flowchart showing a process from a preparation of a book to a selection of a publishing system in FIG. 1;

FIG. 3 is a flowchart showing a process from a connection preparation to an issuing of a publisher ID and a password;

FIG. 4 is a flowchart showing a process from an authentication of a publisher ID and a password to a selection of a publishing system;

FIG. 5 is a flowchart showing a process of making public a registered data of a book file on the Web server;

FIG. 6 is a flowchart showing a process of transmitting a mail to a client;

FIG. 7 is a flowchart showing a process for a client to read a book file;

FIG. 8 is a flowchart showing a process of storing a manufacturing number of a client terminal in a copyright management database;

FIG. 9 is a flowchart showing a process of downloading a book file to a client terminal;

FIG. 10 is a flowchart showing a process of confirming a coincidence between a copyright management code of a book file and a manufacturing number of a client terminal;

FIG. 11 is a flowchart showing a process of storing client data and a client password in a client database; and

FIG. 12 is a flowchart showing a process of distributing a book to a client after a charge has been paid.

### DETAILED DESCRIPTION OF THE PREFERRED EMBODIMENTS

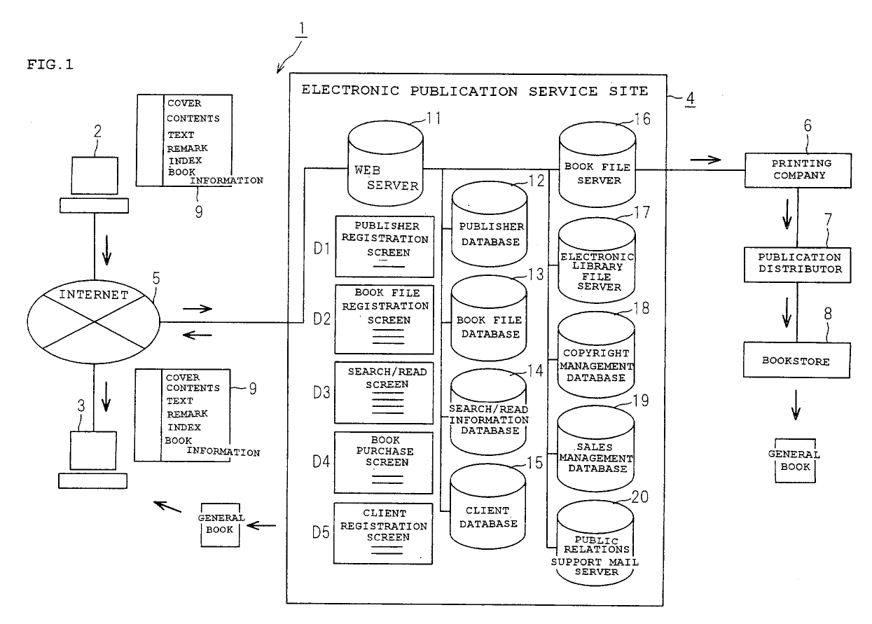

Embodiments of the present invention will be explained with reference to the drawings. FIG. 1 is a block diagram showing a structure of a book preparation/selling system to which the present invention is applied. As shown in the drawing, a book preparation/selling system 1 consists of a publisher terminal 2 installed at a publisher side for preparing a book (a special book, a practical book, a magazine, a paperback, comics), a client terminal 3 installed at a client side for purchasing a book prepared by the publisher based on a request of the client, and an electronic publication service at site 4. These terminals and the service site are connected to each other via the Internet 5.

To simplify the explanation, one publisher terminal 2 and one client terminal 3 are connected to the Internet 5 in FIG. 1. In actual practice, many publisher terminals and many client terminals will exist. Further, the publisher terminal can become a client terminal, and the client terminal can become a publisher terminal.

The publisher terminal 2 and the client terminal 3 shown in FIG. 1 have an electronic book preparation/reading application 9, respectively. The electronic book preparation/reading application 9 has a function capable of preparing a text data and various data (incidental data) including a cover data, a contents data, a remark data, an index data, and book information, that are incidental to the text data, by relating them each other at the time of preparing a document data. The electronic book preparation/reading application 9 also has a function capable of reading these data by relating them each other.

Further, the electronic book preparation/reading application 9 has a function capable of connecting the prepared document data (a book file) to the electronic publication service site 4 via the Internet 5. It also has a function capable of executing various processes for the on-line sales of an electronic book file, including a step of registering publisher that will be described later, a step of registering an electronic book, a step of uploading a book file, a step of preparing a search/read file, a step of automatic-preparing new publication guidance mail to be distributed to the client terminal 3, and a step of reporting a new publication guidance on a sales brochure.

The electronic publication service site 4 collectively carries out the management of book files prepared by the publisher and sales of books (sales of a book file as an electronic book, or sales of a book file as a general book) to the client. The electronic publication service site 4 comprises a web server 11 for distributing various data between the publisher terminal 2 and the client terminal 3 via the Internet 5, a publisher database 12, a book file database 13, a search/read information database 14, a client database 15, a book file server 16, an electronic library file server (an electronic book storing means) 17, a copyright management database 18, a sales management database 19, and a public relations support mail server 20.

The book file server 16 stores an electronic book file prepared by the publisher and obtained through the publisher terminal 2, and book registration data, such as name of the writer and date of publication, incidental to this book file. The publisher database 12 stores the data of the publisher that prepared the book, for example, name of the publisher, an ID (an identification label), a password, a charge payment destination, an address and a telephone number by corresponding the data to the book file stored in the book file server 16. The book file database 13 stores registration data including the name of each book file, the name of the writer, the date of publication, etc. by corresponding them to the book file stored in the book file server 16. Further, the book file database 13 prepares an electronic publication code (a code for publishing an electronic book) and a normal publication code (a code, ISBN number for publishing a general book) The search/read information database 14 registers a keyword for a client to search a book file and read this book file in the book file server 16, and then prepares a search/read file. The search/read information database 14 will register, for example, such words that indicate characteristics of the book file included in the contents data, the cover data, and the index data that are incidental to the book file as keywords so that the information stored in the search/read information database 14 will be available for a client who wants to search.

The client database 15 stores data of the client who purchases the book file prepared by the publisher in the form of an electronic book or in the form of a general book. The client database 15 stores the name of the client, an ID (an identification label), a password, an address, and a telephone number.

When a client has purchased a book file in the form of the electronic book, the electronic library file server 17 stores a file of an electronic book in accordance with the client's request. In other words, the electronic library file server 17 is set with a storage area for each client who desires the storage of the electronic book. The client can read the electronic book stored in the electronic library file server 17 using the client terminal 3 via the Internet 5. However, the downloading of the electronic book is prohibited.

In order to prevent in advance such a trouble that a book file prepared by the publisher is illegally copied, the copyright management database 18 stores the manufacturing serial number of the client terminal 3 (or any information particular to the terminal that has a function equivalent to this) as a copyright protection function corresponding this information to the client data registered in the client database 15. The copyright management database 18 also issues a copyright management code to the book file that is published as the electronic book.

Recently, in many cases, a client owns two terminals of a desktop personal computer and a mobile personal computer (a notebook personal computer) so that it is also possible to allocate two client terminals to one client. The copyright protection function is not limited to the above-mentioned data particular to the terminal, and it is also possible to employ other methods.

The sales management database 19 manages various kinds of charging data such as fees for registering a book file prepared by the publisher to the electronic publication service site 4, fees incurred when the client has purchased an electronic book or a general book, royalty to be paid to the publisher for the purchased electronic book, and payment to be made to the publisher for the purchased general book. The public relations support mail server 20 will notify the book file publisher terminal that the book file has been registered at the electronic publication service site 4. At the same time, the public relations support mail server 20 will proceed to send a new publication guidance mail to the client terminal 3, and will proceed to run a book notice on a sales brochure page to be released on the Web server 11.

The Operation of the Book Preparation/Selling System

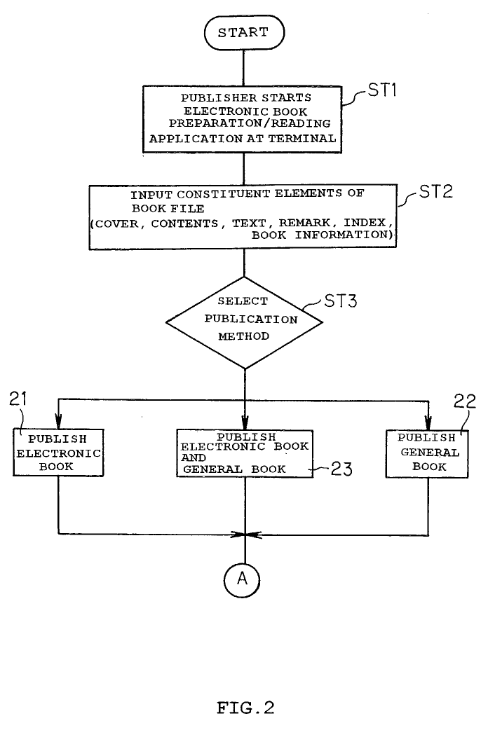

Next, the operation of the book preparation/selling system using the network with reference to the embodiment having the above-described structure will be explained. FIGS. 2 to 6 are flowcharts showing the process of registering a book file prepared by the publisher to the electronic publication service site 4.

First, the publisher starts the electronic book preparation/reading application (step ST1 in FIG. 2), inputs constituent elements of a book file by using the electronic book preparation/reading application (step ST2), and prepares the book file. As the constituent elements of the book file, there are text data, cover data, contents data, remark data, index data, and book information. These items are prepared by relating them each other.

Next, the publisher selects any one method of publishing the prepared book from the following three methods including “publication of an electronic book” 21, “publication of a general book” 22, and “publication of an electronic book and a general book” 23 (step ST3). The publication of an electronic book is a method of providing a prepared book to the client in the form of an electronic book by downloading the electronic book to the client terminal 3. The publication of a general book is a method of providing a prepared book to the client in the form of a printed book or a document printed on paper by printing the data of the electronic book according to a request of the client.

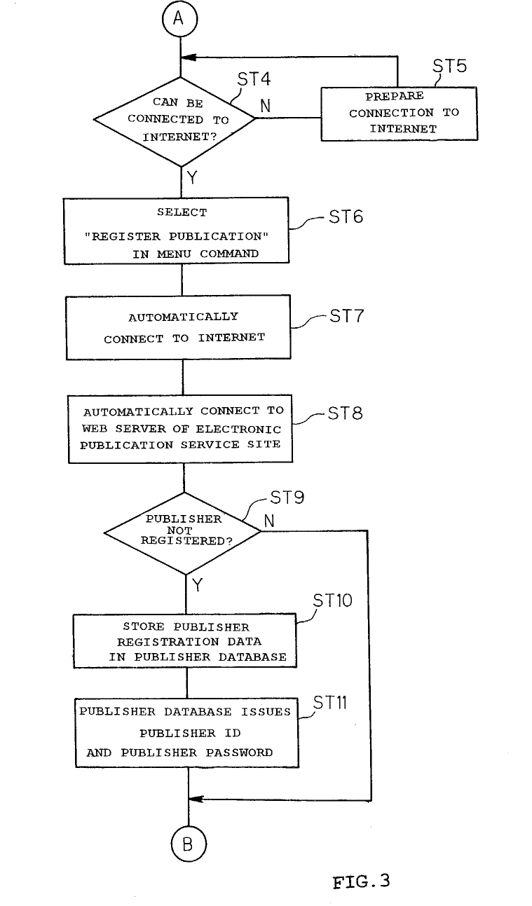

Thereafter, as shown in FIG. 3, a decision is made as to whether or not the publisher terminal 2 can be connected to the Internet 5 (step ST4). If the preparation of connection is not established (NO at step ST4), the connection will be prepared (step ST5).

When the connection to the Internet 5 has been prepared (YES at step ST4), the publisher operates to register the publication of the prepared book file by using the publisher terminal 2 (step ST6). Specifically, the publisher clicks on “register the publication” of a menu command (not shown), for example.

With this arrangement, the publisher terminal 2 is connected to the Internet 5 (step ST7), and is further connected to the Web server 11 of the electronic publication service site 4 via the Internet 5 (step ST8).

The Web server 11 confirms the publisher data of the connected publisher terminal 2, and decides whether or not the publisher has already been registered (step ST9). When the publisher has not yet been registered (YES at step ST9), the registration data of the publisher is stored in the publisher database 12 (step ST10). At the same time, the publisher database 12 issues a publisher ID and a publisher password (step ST11). When the publisher has already been registered (NO at step ST9), the processing at step ST10 and ST11 are not carried out.

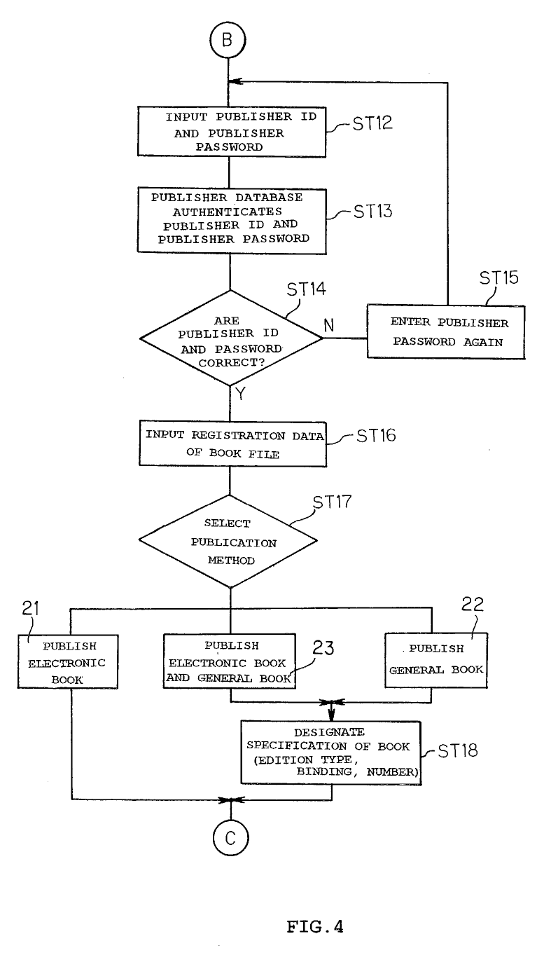

Next, as shown in FIG. 4, the publisher inputs the publisher ID and the publisher password from the publisher terminal 2 (step ST12). The publisher database 12 of the electronic publication service site 4 authenticates the publisher ID and the publisher password that are inputted (step ST13). Then, on the publisher registration screen shown by a reference letter D1 (FIG. 1), a decision is made as to whether or not the publisher ID and the publisher password are correct (step ST14). When there is an error (NO at step ST14), this fact is notified to the publisher. When the publisher has received this notification, the publisher will enter the publisher ID and the publisher password again(step ST15).

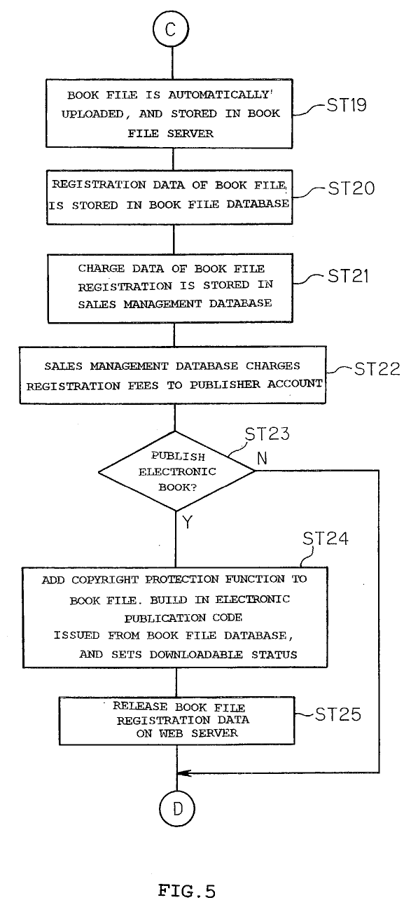

When it has been confirmed that the input publisher ID and the input publisher password are correct (YES at step ST14), the publisher inputs the registration data of the book file (the name of the book file, the writer, the publication date, etc.) (step ST16), and then selects the publication method of the book file to be published (step ST17). When the publication of a general book has been selected, the processing for designating the specification of the general book to be published (the edition type, the binding, the number, etc.) is carried out (step ST18). Then, the book file is uploaded to the electronic publication service site 4 based on a predetermined operation, and is then stored in the book file server 16 (step ST19) (FIG. 5).

In this case, on the display screen of the publisher terminal 2, a list of the book file registration screen data is displayed as shown by a reference letter D2 (FIG. 1). The publisher confirms the contents, and when there are no problems in the contents, the publisher processes to determine the registration. As a result, the book file registration data is stored in the book file database 13 (step ST20). The data of the fees required for registering the book file is stored in the sales management database 19 by corresponding this data to the publisher (step ST21).

This registration fee is paid from the account of the publisher on this date or at a later date (step ST22). Thus, the electronic publication service site 4 can collect the book file registration fee from the publisher.

When the book file stored in the book file server 16 is to be published as an electronic book (YES at step ST23), a copyright protection function is added to the book file, and an electronic publication code issued from the book file database 13 is built into the book file, such that the book file can be downloaded to the client 3 (step ST24). Further, the book file registration data is released on the Web server 11 (step ST25). When the book file is not published as an electronic book (NO at step ST23), the processing at steps ST24 and ST25 are not carried out.

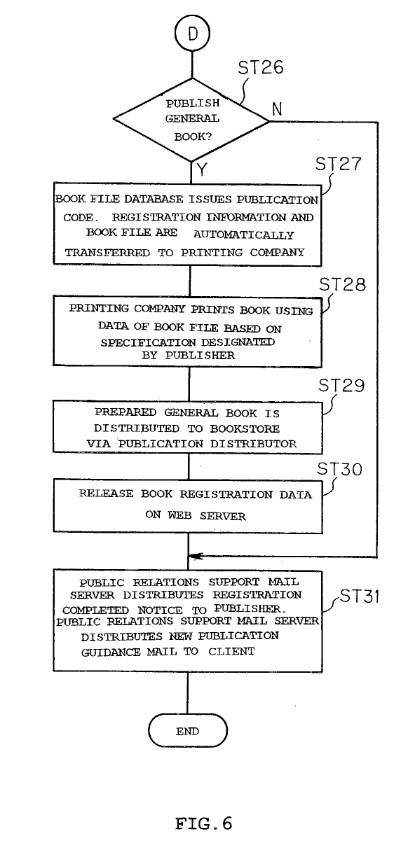

On the other hand, as shown in FIG. 6, when the book file is to be published as a general book (YES at step ST26), the book file database 13 issues a publication code (a normal publication code) corresponding to this general book. This publication code, the registration data of the book file, and the book file data stored in the book file server 16 are transferred to a printing company 6 (step ST27). The printing company 6 receives these data, and prints the general book by using the data of the book file based on the specification designated by the publisher (the specification designated at step ST18) (step ST28). The printed general book is distributed to a bookstore 8 via a publication distributor 7 (step ST29). The book registration data which includes a notice that the general book has been published is released on the Web server 11 (step ST30).

Then, the public relations support mail server 20 distributes a mail to the publisher terminal 2 to notify that the registration of the general book has been completed, and at the same time, distributes a new publication guidance mail to the client terminal 3 (step ST31). Following these steps, the registration of the book file prepared by the publisher to the electronic publication service site 4 (the registration of the book file as an electronic book or a general book) is completed.

Purchase of an Electronic Book or a General Book

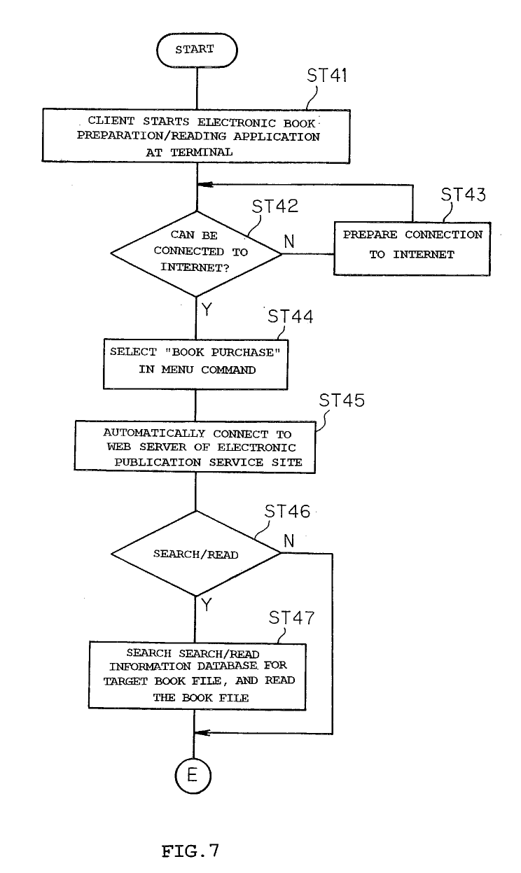

FIGS. 7 to 12 are flowcharts showing a process for the client to purchase a book file registered in the electronic publication service site 4. The process of purchasing an electronic book or a general book will be explained with reference to these drawings.

First, the client starts the electronic book preparation/reading application 9 at the client terminal 3 (step ST41 in FIG. 7). A decision is made as to whether or not it is possible to connect to the Internet 5 through the electronic book preparation/reading application 9 (step ST42). When it is not possible to connect to the Internet 5 (NO at step ST42), the connection to the Internet 5 is prepared (step ST43).

When the connection to the Internet 5 (YES at step ST42) has been successfully made, a message showing the intention of purchasing the book is inputted using the electronic book preparation/reading application 9 (step ST44). Specifically, “purchase a book” in a menu command (not shown) will be clicked. With this operation, the client terminal 3 is connected to the Web server 11 of the electronic publication service site 4 via the Internet 5 (step ST45).

When the client wants to search for a published book file and read this book file (YES at step ST46), he/she indicates a search/read screen D3 (FIG. 1) displayed on the display screen of the client terminal 3. Then, the client searches the search/read file stored in the search/read information database 14 for a desired book file, and reads the book file (step ST47). In this case, the publisher that has prepared the book file sets up the reading range. For example, the client can read only the contents, only the cover, or a part of the text data. When it is not necessary to search for/read an electronic book (that is, the case the client has already determined the book to purchase) (NO step ST46), the processing at step ST47 is not carried out.

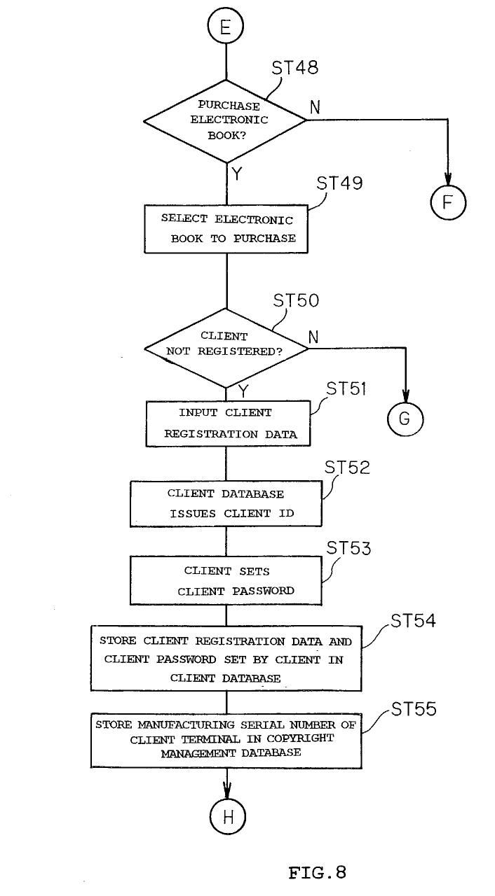

Then the client determines whether he/she wants to purchase an electronic book (whether to purchase the book file in the form of an electronic book) or not (step ST48). When the client wants to purchase the electronic book (YES at step ST48), he/she will proceed to purchase a desired electronic book viewing a book purchase screen D4 on the client terminal 3 (step ST49) (FIG. 8).

When the client has not yet been registered in the electronic publication service site 4 (YES at step ST50), the client inputs client registration data (such as name, address and a telephone number that are his/her own particular data) from the client terminal 3 (step ST51). The client database 15 of the electronic publication service site 4 issues a client ID to this client (step ST52). The client sets a client password at the client terminal 3 (step ST53).

The client registration data and the client password are stored in the client database 15 (step ST54) Further, the manufacturing serial number of the client terminal 3 is stored in the copyright management database 18 in the form of a copyright management code that corresponds to the client registration data (step ST55). Based on this arrangement, a message that the copyright management code has been set is displayed on a client registration screen D5. In this case, if two terminals are allocated to one client, the client who has two personal computers, for example, a desktop personal computer and a mobile personal computer (a notebook personal computer), can utilize the terminals effectively.

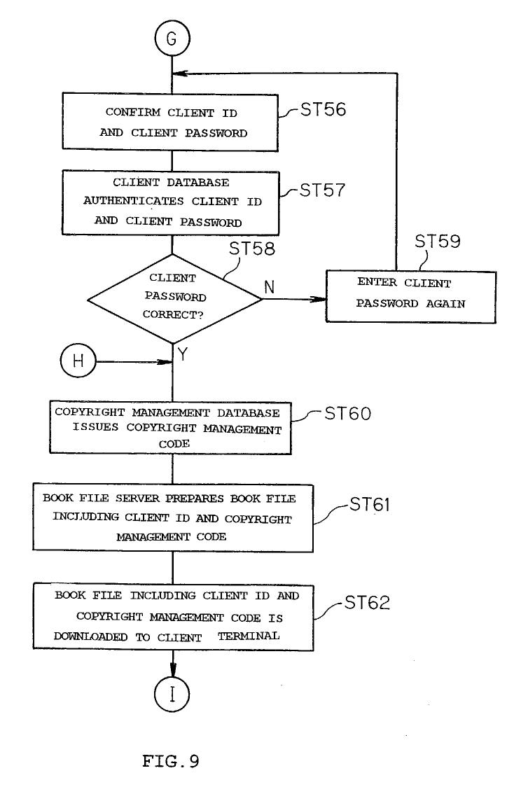

When the client registration has already been completed, the process at step ST50 becomes NO. As shown in FIG. 9, the already registered client ID and the client password are confirmed (step ST56). Then, the client database 15 authenticates the client ID and the client password (step ST57). When there is an error in the client password (NO at step ST58), the client password will be re-entered (step ST59).

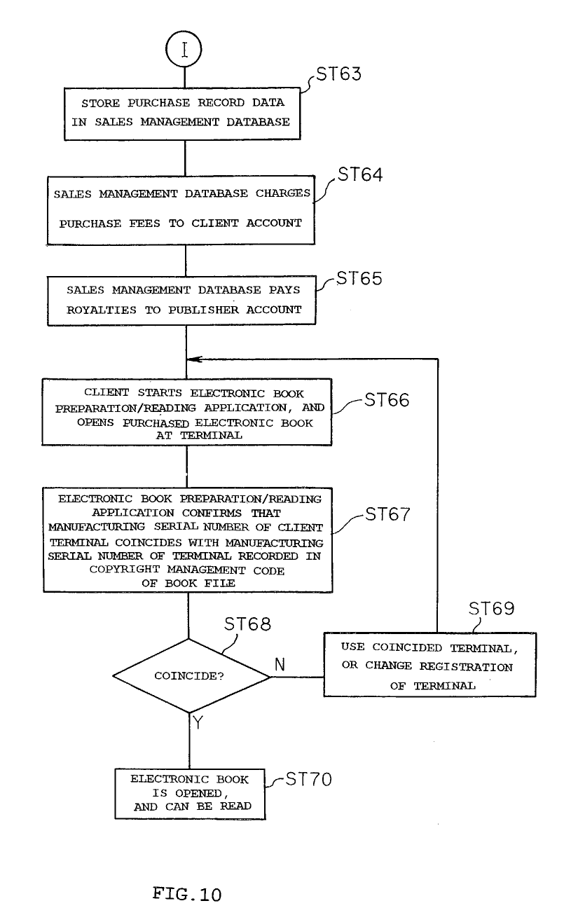

When the client password is correct (YES at step ST58), or when the processing at step ST55 has been finished, the copyright management database 18 issues a copyright management code (step ST60). Further, the book file server 16 prepares a book file which includes the client ID and the copyright management code (step ST61). The prepared book file is downloaded to the client terminal 3 as an electronic book (step ST62). The sales management database 19 stores the purchase record data of the client's purchase (step ST63). Based on this purchase record data, the sales management database 19 carries out the process of making the charge of the purchased electronic book paid from the account of the client (step ST64) (FIG. 10). Further, the sales management database 19 carries out the process for paying the royalties to the account of the publisher of the electronic book corresponding to the electronic book purchased by the client (step ST65). Thus, the publisher can collect the royalties.

The client starts the electronic book preparation/reading application 9 at the client terminal 3, and opens the file of the electronic book that has been purchased and downloaded (step ST66). The electronic book preparation/reading application 9 confirms the manufacturing number of the client terminal 3 and the manufacturing number of the terminal recorded in the copyright management code of the book file corresponding to the downloaded electronic book. The electronic book preparation/reading application 9 confirms whether these manufacturing numbers coincide with each other or not (step ST67). When these manufacturing numbers do not coincide with each other (NO at step ST68), the terminal is changed to a one having the same manufacturing number, or the registered terminal is changed (step ST69). Then, the processing at steps ST66 and ST67 is repeated. When the manufacturing numbers coincide with each other (YES at step ST68), it becomes possible to open the file of the purchased electronic book at the client terminal 3, and the client can read the contents (step ST70). In this way, the client can obtain the electronic book in a simple procedure.

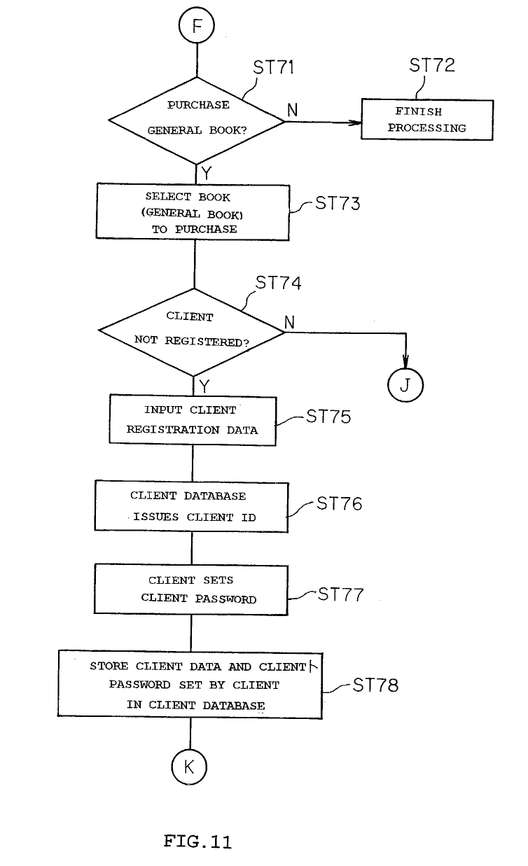

When the client purchases the book file as a general book, the process at step ST48 becomes NO (FIG. 8), and the process at step ST71 becomes YES (FIG. 11). Then he/she will proceed to purchase the book file in the form of a general book on the client terminal 3 (step ST73). When the client has not yet been registered in the electronic publication service site 4 (YES at step ST74), he/she will input client registration data from the client terminal 3 (step ST75). The client database 15 of the electronic publication service site 4 issues a client ID to this client (step ST76). The client sets a client password at the client terminal 3 (step ST77). The client registration data and the client password are stored in the client database 15 (step ST78).

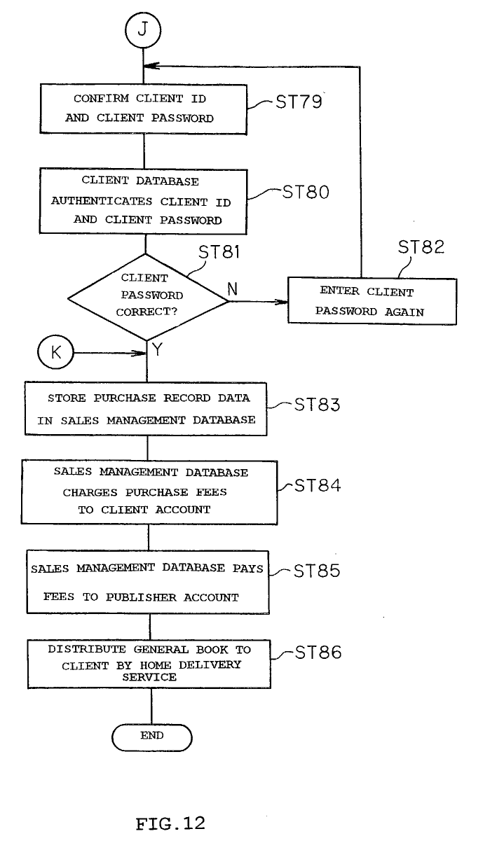

When the client registration has already been completed, the process at step ST74 becomes NO. The already registered client ID and the client password are confirmed (step ST79 in FIG. 12). Then, the client database 15 authenticates the client ID and the client password (step ST80). When there is an error in the client password (NO at step ST81), the client will be required to enter his/her password again (step ST82).

When the client password is correct (YES at step ST81), or when the processing at step ST78 has been finished, the sales management database 19 stores the purchase record data (step ST83). Based on this purchase record data, the sales management database 19 carries out the process of charging the fees for the purchased general book to the client's account (step ST84). Further, the sales management database 19 carries out the process for paying the credit corresponding to the general book purchased by the client to the publisher's account (step ST85).

Thereafter, the book file that the client wants to purchase is transferred from the book file server 16 to the printing company 6, where the book file is printed and bound as a general book. The general book is distributed to the client via the publication distributor 7 or the bookstore 8 (step ST86) so that the client can obtain the desired book file in the form of the general book. When the process at step ST71 becomes NO, the processing will be ended (step ST72).

Each client can set his/her own storage area in the electronic library file server 17 of the electronic publication service site 4 as the need arises. When the client utilizes this electronic library file server 17, he/she can store the file of the purchased electronic book in the electronic library file server 17. Only the client who has made the setting can access the electronic book stored in the electronic library file server 17. Therefore, the client can read the electronic book in the electronic library file server 17 from the client terminal 3 according to the needs.

With the above arrangement, when the client connects a mobile personal computer (the personal computer set as the client terminal) to the Internet 5, and inputs his own ID and his own password, the client can read the electronic book stored in the electronic library file server 17 wherever he/she goes. For example, when the client makes a business trip abroad, and he/she wants to read the electronic book that he/she purchased in the past, the client can read the electronic book stored in the electronic library file server 17 there by using the mobile personal computer. Therefore, the client does not need to bring any documents and data, etc. as printed materials.

As explained above, according to the system of the present invention, each publisher terminal 2 and each client terminal 3 have the electronic book preparation/reading application 9, respectively. Therefore, they can connect a book file prepared by the publisher to the Web server 11 of the electronic publication service site 4 via the Internet 5 in the status of the book file (for example, without the need of changing the format or without the need of setting the layout).

Further, when the electronic book preparation/reading application 9 is used, various processes for the online sales of the electronic book or the general book can be performed in the electronic publication service site 4 with a simple procedure. These processes include the publisher registration process, the book file registration process, the uploading of a book file, the automatic preparation of a search/read file, the automatic distribution of a new publication mail to the clients, and the running a publication notice on a sales brochure. As a result, it is possible for the publisher to simplify various processes from the preparation of a book file to the publication and sales of the book file. Immediately after the book file has been prepared, it is possible to release the information that the book file has been published so as to notify the client.

Additionally, the client can utilize the client terminal 3 equipped with the electronic book preparation/reading application 9, to search a book file that has been released on the electronic publication service site 4, and read a part of the contents of the book file. Therefore, the client can easily find a book file that he/she wants to purchase. When the client wants to purchase the book file, he/she can download this book file as an electronic book with a simple operation. When the client wants to purchase the book file as a general book, he/she can purchase the general book with the on-line procedure. Further, the client can obtain the general book via the bookstore 8. Thus, the purchase procedure can be extremely simplified.

When the book file prepared by a publisher is sold as an electronic book, a copyright protection function is added to this book file. Therefore, it is possible to prevent the book file from being illegally copied. Further, since the client can store the electronic book that he/she purchased in the electronic library file server 17, the client can read the file of the electronic book by making access to the electronic library file server 17 at any time he/she wants.

As explained above, in accordance with the book preparation/selling method and the book preparation/selling system using the network of the present invention, the publisher terminals and the client terminals comprise electronic book preparation/reading applications, respectively, that enable the respective terminals to make direct access to the electronic publication service site via the network. Therefore, it is possible to upload the book file prepared by the publisher to the electronic publication service site in the status of the book file as it is. The client can also download this book file as an electronic book. Further, a knowledge/information circulation system of the electronic document can be performed efficiently by using one application.

With the above arrangement, it is possible to make efficient and optimize the book file manufacturing process, the distribution process, the copyright management process, the sales management process, and the reading process. Therefore, unlike the conventional practice, it is not necessary to carry out various processes including the setting of the format and the setting of the publication form, each time during the period from when the publisher has prepared an electronic book draft until when the electronic book is sold to the client, which enables to execute on-line selling and purchasing of an electronic book or a general book with an extremely simply procedure.

Further, the client can obtain a desired book file in the form of an electronic book or a general book, or in both forms so that he/she can have more options to purchase a book. In addition, since a copyright protection function is added to a book file to be sold as an electronic book, the book file cannot be downloaded by any terminals other than a terminal owned by the client who purchased the electronic book. As a result, it is possible to prevent the book file from being illegally copied.

What is claimed is:

1. A book preparation/selling method using a network, in which each publisher terminal and each client terminal comprise an electronic book preparation/reading application, respectively, for enabling the publisher to prepare a book file that can be directly accessed to an electronic publication service site via the network, and enabling the client to directly search the electronic publication service site for the book file registered in the electronic publication service site and read this book file via the network, thereby making it possible to sell the book file prepared by the publisher to the client via the network, wherein
the publisher prepares the book file by using the electronic book preparation/reading application,
the electronic publication service site stores the book file and the publisher terminal in which they correspond each other, and prepares a search/read file based on the contents of the book file, and
the client searches the search/read file for a book file that he/she wants to purchase and obtains the book file by using the electronic book preparation/reading application, and stores a charge data of the purchased book file in the electronic publication service site by corresponding the charge data to the client and the publisher.

2. The book preparation/selling method using a network according to claim 1, wherein
the client downloads a selected book file via the network by using the electronic book preparation/reading application, and purchases the book file in the form of an electronic book.

3. The book preparation/selling method using a network according to claim 2, wherein
the electronic publication service site comprises an electronic book storage area for the client's private use, and the electronic book storage area stores an electronic book that the client purchased, and enables only the client who purchased the electronic book to read the stored electronic book.

4. The book preparation/selling method using a network according to any one of claims 1 to 3, wherein the book file prepared by using the electronic book preparation/reading application comprises a copyright protection function.

5. The book preparation/selling method using a network according to claim 4, wherein
the copyright protection function is a function of authenticating the coincidence between an ID which is particular to a client terminal of a client who wants to purchase a book file in the form of an electronic book and an ID added to this electronic book, and enabling the electronic book to be opened only at the client terminal of which ID authentication has been confirmed.

6. The book preparation/selling method using a network according to any one of claims 1 to 5, wherein
the electronic publication service site distributes a book file selected by the client to a printing company, and the printing company prepares a general book based on this book file, and
the client purchases the selected book file in the form of the general book via the printing company.

7. The book preparation/selling method using a network according to any one of claims 1 to 6, wherein
the electronic book preparation/reading application can prepare a text data that becomes a constituent element of a book file and an incidental data that is incidental to the text data, by relating them each other.

8. The book preparation/selling method using a network according to claim 7, wherein
the incidental data includes at least one of a cover data, a contents data, a remark data, an index data, and book information that are relevant to the text data.

9. A book preparation/selling system using a network comprising an electronic publication service site connected to the network, for selling a book file prepared by a publisher to a client by using an electronic book preparation/reading application via the network, wherein
a publisher terminal owned by the publisher and a client terminal owned by the client comprise an electronic book preparation/reading application, respectively, for enabling the publisher to prepare a book file that can be directly accessed to the electronic publication service site via the network and enabling the client to directly search for a book file registered in the electronic publication service site and read the book file via the network,
said electronic publication service site comprises
a book file storing unit for storing the book file prepared by the publisher by relating the book file to the publisher,
a search/read information storing unit for preparing and storing a search/read file of the book file stored in the book file storing unit, and
a sales management data storing unit for storing charge data of the book file sold to the client, wherein
the client searches a book file stored in the search/read information storing unit and reads the searched book file by using the electronic book preparation/reading application, and selects a book file that he/she wants to purchase, and
the electronic publication service site enables the client to download the book file selected by him/her as an electronic book, charges the client for the price of the selected book file, and stores the charge data in the sales management data storing unit.

10. The book preparation/selling system using a network according to claim 9, wherein
the electronic publication service site comprises an electronic book storing unit for the client's private use, said electronic book storing unit stores an electronic book that the client purchased, and enables only the client who purchased the electronic book to read the stored electronic book.

11. The book preparation/selling system using a network according to claim 9 or 10, wherein the book file prepared by using the electronic book preparation/reading application comprises a copyright protection function.

12. The book preparation/selling system using a network according to claim 11, wherein
the copyright protection function is a function of authenticating the coincidence between an ID particular to a client terminal of a client who wants to purchase a book file in the form of an electronic book and an ID added to this electronic book, and enabling the electronic book to be opened only at the client terminal of which ID authentication has been confirmed.

13. The book preparation/selling system using a network according to any one of claims 9 to 12, wherein
the electronic publication service site is connected to a printing company via the network, and the printing company prepares a book file that the client wants as a general book, and distributes the prepared general book to the client.

14. The book preparation/selling system using a network according to any one of claims 9 to 13, wherein
the electronic publication service site comprises a publisher data storing unit for storing registered data of the publisher, and a client data storing unit for storing registered data of the client.

15. The book preparation/selling system using a network according to claim 9, wherein
the electronic publication service site collectively carries out the management of book files prepared by the publisher, and sales of books (sales of a book file as an electronic book, or sales of a book file as a general book) to the client,
said electronic publication service site comprises a Web server for distributing various data to the publisher terminal and the client terminal via the Internet, a publisher database, a book file database, a search/read information database, a client database, a book file server, an electronic library file server (an electronic book storing unit), a copyright management database, a sales management database, and a public relations support mail server.

16. The book preparation/selling system using a network according to any one of claims 9 to 15, wherein
the electronic book preparation/reading application can prepare a text data which becomes a constituent element of a book file and an incidental data which is incidental to the text data, by relating them each other.

17. The book preparation/selling system using a network according to claim 16, wherein
the incidental data includes at least one of a cover data, a contents data, a remark data, an index data, and book information that are relevant to the text data.
